(19) United States
(12) Patent Application Publication
(10) Pub. No.: US 2016/0034839 A1
(43) Pub. Date: Feb. 4, 2016

(54) METHOD AND SYSTEM FOR AUTOMATIC ASSESSMENT OF A CANDIDATE"S PROGRAMMING ABILITY

(71) Applicant: Varun AGGARWAL, Gurgaon, HR (IN)

(72) Inventors: Varun AGGARWAL, Gurgaon (IN); Shashank SRIKANT, Bangalore (IN); Vinay SHASHIDHAR, Gurgaon (IN)

(73) Assignee: Varun AGGARWAL, Gurgaon, HR (IN)

(21) Appl. No.: 14/435,174

(22) PCT Filed: Nov. 21, 2013
(86) PCT No.: PCT/IB13/60297

§ 371 Date: Aug. 10, 2015

(30) Foreign Application Priority Data
Nov. 21, 2012 (IN) 3559/DEL/2012
Nov. 21, 2012 (IN) 3560/DEL/2012
Nov. 21, 2012 (IN) 3562/DEL/2012

(51) Int. Cl. G06Q 10/06

(52) U.S. Cl. CPC G06Q 10/06398

(57) ABSTRACT

A method and system for automatic assessment of a person's programming skill has been provided. The method involves gathering an input code from the person in relation to a programming problem statement. The input code is then processed using a processor. One or more scores are determined from the input code based on at least one of a time complexity and taxonomy of test cases. And finally, a performance report corresponding to the programming ability of the person is displayed on a display device based on the one or more scores

This is a national Stage Filing of PCT/IB2013/060297, International filing date of 21 Nov. 2013, and priority date of 21 Nov. 2012.

### FIELD OF INVENTION

The present invention relates to information technology and, more specifically to a method and system for automatic assessment of a person's programming skills.

### BACKGROUND

There is a growing need for new assessment techniques in the context of recruitment of a programmer in a software development companies, teaching in universities or training institutes, Massively Open Online Courses (MOOCs), etc. The immense problems associated with manual assessment methods have given birth to the subject of automatic assessment methods. Currently, there is a variety of automatic assessment methods used to test the programming skills of a person.

One of the most common methods used for automatic assessment of programs is solely based on number of test cases they pass. This methodology does not give the fairest results because, programs which pass a high number of test cases might not be efficient and may have been written using bad programming practices. Conversely, a program which passes a low number of test cases doesn't provide an insight into what is the problem with the logic of the program. Hence, an approach which solely relies on the aggregate number of test cases passed does not give a fair marker of programming quality. Also, prior attempts to lay down a marker have entailed calculating memory usage when a program is run, which again fails to provide clarity with regard to assessment of programming skills. The process of benchmarking with a predefined ideal solution on the basis of weak metrics and generating a score is also known in the art, but it falls short of correctly objectifying a programmer's coding skills.

Despite a keen interest and widespread research in automatic evaluation of human skills, there is a lack of a solution, specifically in the field of assessing programming skills, which tries to shed light on what could be possible logical errors with an incorrect program and whether a logically correct or near correct program is an efficient solution to the problem. Thus a need persists for further contribution in this field of technology.

### SUMMARY

An embodiment of the present invention provides a method for assessing the programming ability of a person, the method comprises the following steps: gathering an input from the person in relation to a test containing at least one programming problem statement; processing the input and determining one or more scores based on at least one of an algorithmic time complexity and a taxonomy of test cases thereby; and displaying a performance report comprising the one or more scores determined in the previous step.

Another embodiment of the present invention provides a system for assessing programming ability of a candidate, wherein the system comprises three parts: an input gathering mechanism, a processing mechanism and an output mechanism. The input gathering mechanism consists of the candidate registering his code or program in response to the problems presented in the test. The code is then compiled and processed based on the prescribed metrics by the processing mechanism. An output is provided by the output mechanism through any human-readable document format or via e-mail or via a speech assisted delivery system or any other modes of public announcements.

These and other aspects, features and advantages of the present invention will become apparent from the following detailed description of illustrative embodiments thereof, which is to be read in connection with the accompanying drawings.

### BRIEF DESCRIPTION OF DRAWINGS

The features of the present invention, which are believed to be novel, are set forth with particularity in the appended claims. Embodiments of the present invention will hereinafter be described in conjunction with the appended drawings provided to illustrate and not to limit the scope of the claims, wherein like designations denote like elements, and in which

FIG. 1 shows a flowchart showing the steps involved in assessing the programming ability of a person, in accordance with an embodiment of the present invention;

FIG. 2 shows the block diagram of a system for assessing the programming ability of a person, in accordance with an embodiment of the present invention;

FIG. 3 shows a portion of the sample performance report, in accordance with an embodiment of the present invention; and

FIG. 4 shows another portion of the sample performance report, in accordance with an embodiment of the present invention.

### DETAILED DESCRIPTION OF PREFERRED EMBODIMENTS

As used in the specification and claims, the singular forms “a”, “an” and “the” include plural references unless the context clearly dictates otherwise. For example, the term “an article” may include a plurality of articles unless the context clearly dictates otherwise.

There may be additional components described in the foregoing application that are not depicted on one of the described drawings. In the event such a component is described, but not depicted in a drawing, the absence of such a drawing should not be considered as an omission of such design from the specification.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

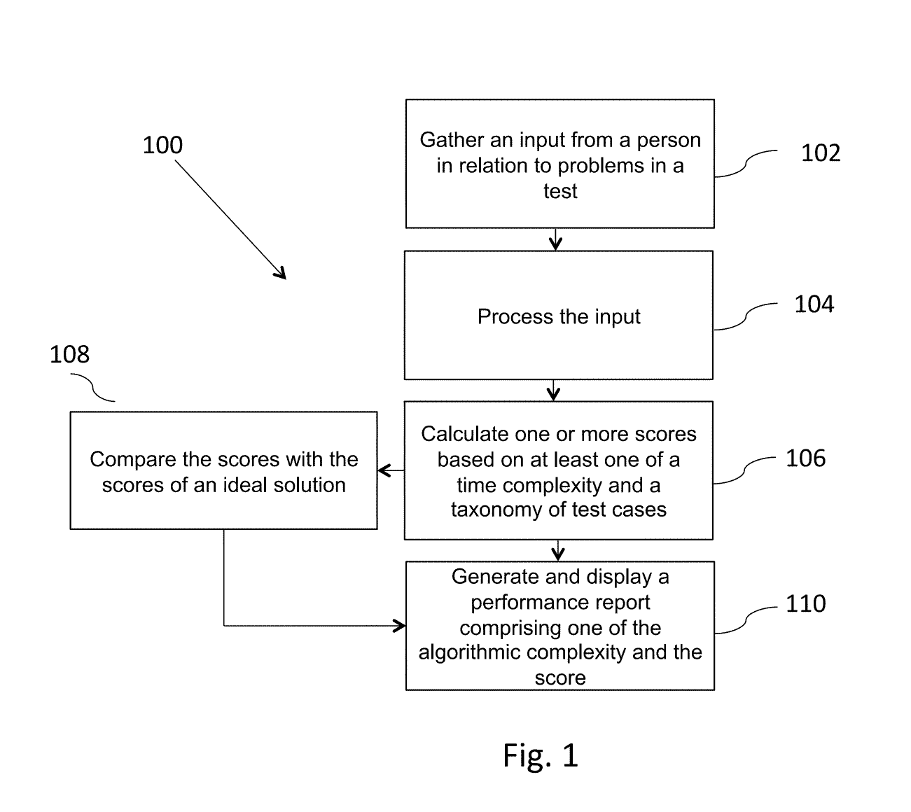

FIG. 1 illustrates a method 100 for assessing the programming ability of a candidate according to an embodiment of the disclosure. The Candidate may be a person (of any gender or age-group), group of persons (of any gender or age-group), an organization or any entity worthy of participation in such an assessment. The candidate is presented with a set of problems in the form of a test, which require answers, in the form of an input code from the candidate. The input code can be complete or partial and in any one of an object oriented programming language, a procedural programming language, a machine language, an assembly language, pseudo-code language and an embedded coding language. It should be appreciated that the terms ‘code’, ‘program’, ‘input code’ and ‘input program’ have been used interchangeably in this description. The test can be conducted on any platform, for instance, it may be conducted on systems with Windows, UNIX, Linux, Android or Mac OS, or it may be conducted on any device like computers, mobiles, and tablets or otherwise.

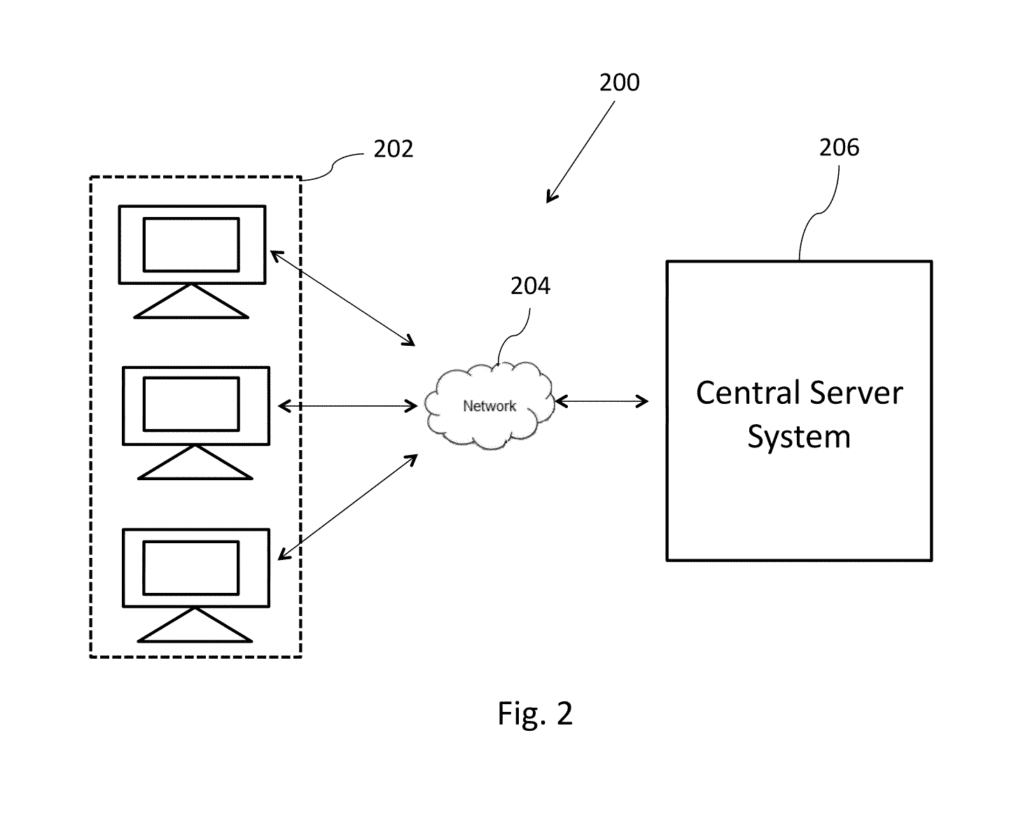

The test can be conducted through either an online or an offline platform. FIG. 2 illustrates the block diagram of a system 200 showing the test being conducted through an online platform according to an embodiment of the disclosure. It should be appreciated that the test can also be downloaded in the form of a test delivery on a stand-alone system and taken offline.

As shown in flowchart of FIG. 1, at step 102, the input code is accepted through a web-based interface, a desktop application based interface, a mobile-phone app based interface, a speech-based interface or otherwise. At step 104, the code is processed by a processor. In an embodiment, the processor may be a compiler suite having a compilation and a debug capability.

In the next step 106, the processed input code is used to infer one or more scores based on at least one of a time complexity of the algorithm and a taxonomy of test cases. In an embodiment as shown in FIG. 2 for an online assessment platform, the scores are calculated in a central server system 206. In another embodiment for an offline assessment platform, the scores are calculated on the stand-alone system offline. The taxonomy of test cases may be prepared by an expert, crowd-sourced, inferred by a static or dynamic code analysis, be generic or specific to a given problem or by using any of these sources in conjunction with each other. Hence, time complexity of the algorithm and the taxonomy of test cases are considered underlying metrics for assessing the programming skills of the candidate.

The time complexity is a measure of the time taken by the code to run depending on the input characteristics (for example, size of an input, a subset of the possible input domain determined by some logic, etc.). One or more of worst case, best case or average case may be reported. Other than these, the complexity can be reported as the time of execution expressed as a statistical distribution or random process over the different test-cases and size of test cases. For instance, the complexity (execution time) may be represented as a continuous probability distribution such as a Gaussian distribution, with the mean and standard deviation being functions of the size of the input or the number of input parameters or any other inherent parameter of the problem statement. In another representation, a statistically balanced percentile representation of each code solution is reported. For instance, if a problem can be solved in two ways—efficiently in the order O(n) and inefficiently in the order O(n²), where ‘n’ is an input characteristic, size of the input—the percentile statistic of how many candidates who have solved the problem in the two possible ways is reported along with the actual time complexity.

A few other examples of representing time complexity as a function of the input size, n, are:

T(n)=O(n)

T(n)=O(Log n)

T(n)=O(2ⁿ)

T(n) is time complexity as a function of input size. In the above illustrations, the time complexities are linear, logarithmic and exponential respectively, in the worst case (people skilled in the art will appreciate that the meaning carried by Big-O is worst case time complexity, or likewise the Little O, Little Omega notations).The time complexity can similarly also be a function of one or more of a subsets of the input, the subsets of the input qualified by a condition or characterized by at least one symbolic expression. The time complexity can also be shown graphically with a multiplicity of axis. The axes would essentially comprise scaling of various input parameters and the time taken by the algorithm.

According to another embodiment of the disclosure, the time complexity can also be determined by predicting it using timing information, apart from other statistics, received per passed test case.

According to yet another embodiment of the disclosure, the time complexity can also be determined by modelling the run-time and memory used by the code when executed, by semantic analysis of the code written, by crowd sourcing the complexity measure by a bouquet of evaluators. In one embodiment, the code can be run once or more in a consistent environment for different input characteristics and the time of execution be noted. Then a statistical model may be fit to the observed times using machine learning techniques such as regression, specifically to build polynomial models. The model order shall serve as the complexity of the code in the given scenario. The timing information may be combined with semantic information from code (say existence of a nested loop) to build more accurate models of complexity using machine learning.

The other metric for assessment is the taxonomy of test cases. In one use case, the test cases are classified on the basis of a broad classification. For instance, the test cases are classified as Basic, Advance and Edge Cases. The basic cases include those test cases which demonstrate the primary logic of the problem. The advance cases include those test cases which contain pathological input conditions which attempt to break codes with incorrect/semi-correct implementations. The edge cases include those test cases which specifically confirm whether the code runs successfully on the extreme ends of the domain of inputs. For example, in order to search a number from a list of numbers using binary search, a basic case would correspond to searching from a list of sorted, positive, unequal numbers. An advanced case would require searching from a list of unsorted numbers by first sorting it or by having equal numbers in the list. An edge case would correspond to handling the case when just one/two numbers are provided in the list or similarly, an extreme number of cases are provided as input.

In another use case, the taxonomy of test cases can be determined by working on the symbolic representation of the code (static analysis) and looking at multiple paths traversed by the control flow of the program. One of the metrics for classification could be the complexity of the path traversed during the execution of the test case. In yet another case, one may classify test-cases by groups which follow the same control path in one or more correct implementations for the groups. This can be done by either static or dynamic analysis of the code. These groups may then be either symbolically represented and form the taxonomy. Also, an expert may inspect these groups and give them names which form the taxonomy. Other such static analysis ways may be used.

For example in the following code snippet—

```
foo(a, b){
if(a && b)
        return x;
else
      return y;
}
```

the symbolic expression for the output as a function of the input parameters a and b would be—
o=(a,b)(x)+(a,b)′(y) respectively, corresponding to the two paths of the if-condition.

Thus the categories of the taxonomy can be represented by (a,b) and (a,b)′. An expert can label these two categories as ‘Identical Inputs’ and ‘Non-identical Inputs’.

In another instance, one of the categories can comprise test cases entered by the candidate while testing and debugging his/her code during the evaluation. The nature of test cases entered by peers/crowd while testing/debugging/evaluating a candidate's source code could also help build the taxonomy. For instance, test cases used by candidates who did well in coding can form one category.

In yet another use case, the test cases are classified on the basis of data structures or abstraction models used for writing the code. In yet another use case, the test cases are classified on the basis of correct and incorrect algorithms generally used to solve the coding problem as determined by an expert. For example, if there are two incorrect ways which students generally use to solve the problem, test-cases which would fail in the first way can be classified as one group and those that fail the other as the second group.

In yet another use case, test cases (TC) are classified on the basis of empirical observations on test cases pass/fail status on a large number of attempted solutions to the problem. Those test-cases may be clustered into categories, which show similar pass/fail behaviour across candidates. A matrix may be assembled with different test-cases as rows and candidate attempts as columns. The matrix shall contain 0 for test-case fail for the particular candidate and 1 for a pass. Clustering algorithms such as k-means, factor analysis, LSA, etc. may then be used to cluster similarly functioning test-cases together. The resultant categories may mathematically be represented or given a name by an expert. In another instance of an empirical clustering, test-cases may simply be clustered by their difficulty as observed in a group of attempted solutions to the programming problem. Simple approaches in classical testing theory (CTT) or Item-Response-Theory may be used to derive difficulty.

In yet another use case, that test-cases are classified on difficulty by item response theory, their scores may also be assembled by using their IRT parameters.

The scores reported for each candidate can be inferred from one or more of above mentioned classifications. The code can be run for the set of test-cases classified in a category and a percentage pass result may be reported. For example, scores on test cases under basic, advanced and edge category are reported as number of such cases passed (successfully ran) out of total number of cases evaluated. This is the dynamic analysis method to derive a score. The score may also be determined by static analysis, by a symbolic analysis of code to find test-case equivalence of a given code with a correct implementation of the code.

In one instance, scores may be reported separately on the basis of one or more of the following categories: usage of stacks, usage of pointers, operations (insertion, sorting, etc.) performed in the code or otherwise. In another instance, scores may be reported separately on the basis of one or more of the following categories: design of the solution, logic developed implementation (concepts of inheritance, overloading etc.) of the problem or otherwise.

Along with each of these scores reported against every test-case or a category of the test-cases mentioned in the above points, a statistically balanced percentile may also be reported which would suggest the number of people who have attempted the same problem who have got a similar score on the particular test case or a category of test-case. The percentile may be over different norm groups, such as undergraduate students, graduate students, candidates in particular discipline, particular industry and/or with particular kind of experience.

At step 108, the scores calculated at step 106 for each metric are compared with an ideal score (under ideal implementation of the program) which can be further used for determine a total score. Other metrics such as algorithmic space complexity, memory utilisation, number of compiles, number of warnings and errors, number of runs, etc. may also be used for contributing to the total score.

Finally at the step 110, a performance report comprising these scores is generated and displayed. The performance report may be provided in the form of any human-readable document format (HTML, PDF or otherwise) or via E-Mail or via a speech assisted delivery system or any other modes of public announcements.

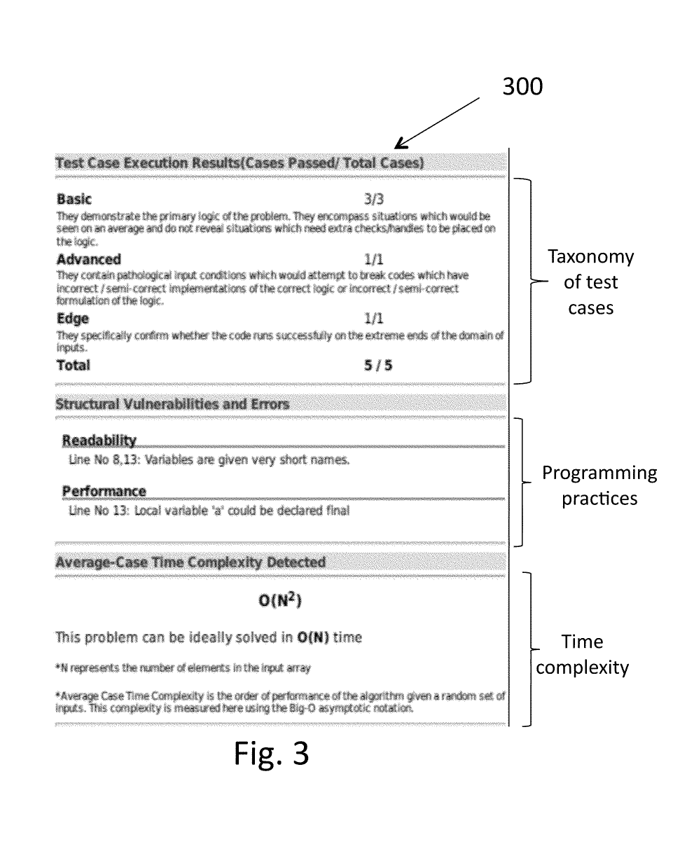

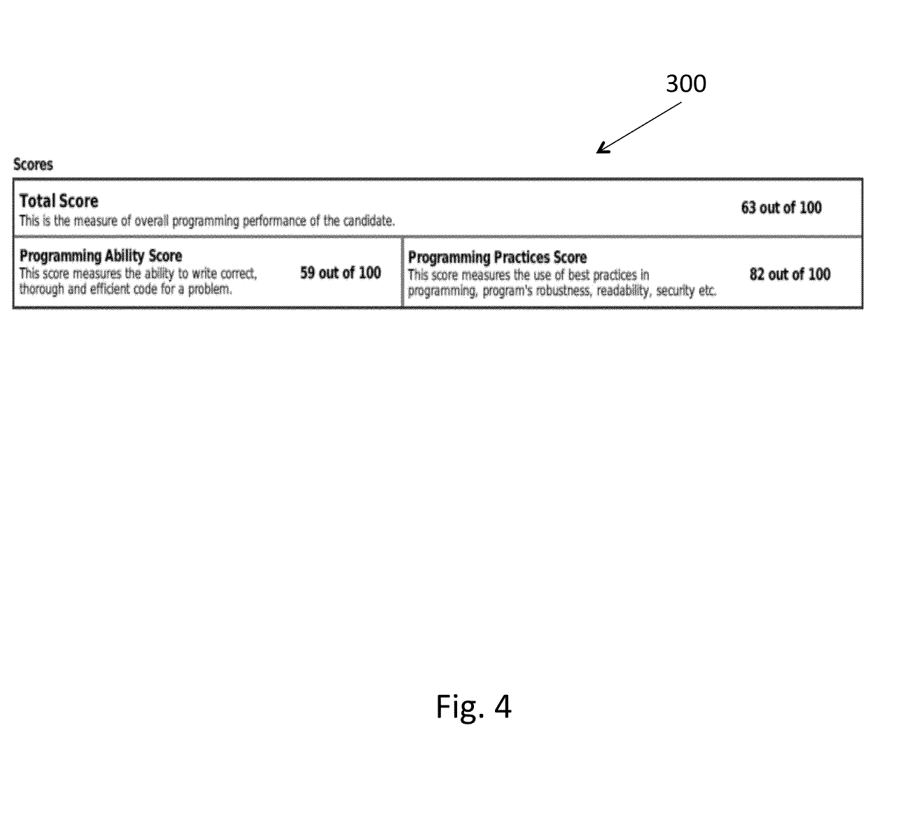

A sample performance report 300 according to an embodiment of the disclosure is shown in FIG. 3 and FIG. 4. FIG. 3 shows a part of the performance report where the input code on the left panel. The candidate's performance based on the metrics, the taxonomy of test cases and the time complexity is reported on the right panel. The right panel also reports the programming practices used by the candidate.

FIG. 4 further displays programming ability score and a programming practices score. The programming ability score is calculated based on the taxonomy of test cases and the time complexity. The programming practices score is calculated on the basis of the programming practices used by the candidate for example readability of the input code. These two scores, the programming ability score and the programming practices score, can be combined to calculate the total score as shown on the top panel of FIG. 4.

The performance report further forms the basis of assessment of the candidate. The performance report can further be used for various purposes. In an example the report may be used for training purposes or providing feedback to the candidate. In another example the performance report may be used as short listing criterion. In yet another example, the report may be used during discussions in interviews or otherwise.

In another use case, the report may be shown to the candidate in real time when he/she is attempting the problem, as a way to get feedback or hints. For instance, the taxonomy of test case scores may guide the candidate what to change in his/her code to correct it. In case of a near-correct code, the complexity information and score can tell the candidate to improve the code such that it has ideal complexity.

According to another embodiment of the disclosure, the system 200 for assessing the programming ability of the candidate is shown in FIG. 2. The system includes a plurality of slave systems 202, connected to a central server system 206 through a network 204. The input is gathered on the plurality of slave systems, processed, and sent to the central server system 202 for the calculation of the one or more scores.

The one or more scores are determined based on at least one of the time complexity and the taxonomy of test cases as mentioned in the disclosure above.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for assessing programming ability of a candidate, the method comprising:
gathering an input code from the candidate in relation to a test, wherein the test includes at least one programming problem statement;
processing the input code and determining one or more scores based on at least one of a time complexity and a taxonomy of test cases; and
displaying a performance report comprising the one or more scores.

2. The method as claimed in claim 1, wherein the test is conducted through one of an online assessment platform and an offline assessment platform.

3. The method as claimed in claim 1, comprising presenting the test to the candidate in one of an object oriented programming language, a procedural programming language, a machine language, an assembly language, pseudo-code language and an embedded coding language.

4. The method as claimed in claim 1, wherein the input code is gathered by one of a web-based interface, a desktop application based interface, a mobile-phone app based interface, a tablet based interface and a speech-based interface.

5. The method as claimed in claim 1, wherein the input code is processed by a compiler suite providing a compilation and a debug capability.

6. The method as claimed in claim 1, wherein the performance report is displayed at least one of in a real time or after a predetermined time interval.

7. The method as claimed in claim 1, wherein the performance report comprises a statistically balanced percentile representation of the one or more scores.

8. The method as claimed in claim 1, wherein the time complexity is proportional to, or an approximation of, the time taken by the code to run as a function of one or more input characteristics.

9. The method as claimed in claim 8, wherein the one or more input characteristics is at least one of an input size, one or more of a subsets of the inputs, the subsets of the input qualified by a condition or characterized by at least one symbolic expression.

10. The method as claimed in claim 1, wherein the time complexity is one of a best case time complexity, an average case time complexity and a worst case time complexity.

11. The method as claimed in claim 1, comprising the time complexity as one of a statistical distribution of a time taken as a function of the input characteristics and a graphical representation depicting a relationship between the time taken and the one or more input characteristics.

12. The method as claimed in claim 1, wherein the time complexity is calculated by estimating the time taken to run the input code for the input characteristics and optionally combined with a function of one or more than one features derived from a semantic analysis of the input code.

13. The method as claimed in claim 1, comprising the taxonomy of test cases to be derived by one of an expert, crowdsourcing, a static code analysis, a dynamic code analysis, an empirical analysis and a combination of all of these.

14. The method as claimed in claim 1, wherein the score based on the taxonomy of test cases is a measure of a percentage of the test cases passed for each category of the taxonomy.

15. The method as claimed in claim 1, comprising the score based on the taxonomy of test cases to be derived through the static code analysis, the dynamic code analysis and a combination of these.

16. The method as claimed in claim 1, wherein the one or more scores is relatively determined by comparing the time complexity of the candidate's input code with that of an ideal implementation for the problem statement.

17. The method as claimed in claim 1, wherein the one or more scores can be combined with one or more scores derived from measurement of at least one of a space complexity, a memory utilisation, programming practices used, one or more number of compiles, one or more runs, one or more warnings, one or more errors, an average time per compile and an average time per run.

18. A system for assessing programming ability of a candidate, the system comprising:
an input gathering mechanism that records an input code from the candidate in relation to a test, wherein the test includes at least one problem statement;
a processing mechanism that compiles the input code and determines one or more scores based on at least one of a time complexity and a taxonomy of test cases; and
an output mechanism that displays a performance report comprising the one or more scores.
